(19) United States
(12) Patent Application Publication
(10) Pub. No.: US 2003/0136761 A1
(43) Pub. Date: Jul. 24, 2003

(54) Via hole defining process performed in one chamber

(76) Inventors: Jen-Jiann Chiou, Hsin-Ying (TW); Pei-Humg Chu, Kaohsiung (TW)

Correspondence Address: J.C. Patents, Inc., Suite 250, 4 Venture, Irvine, CA, 92618, US

(21) Appl. No.: 10/078,316

(22) Filed: Feb. 15, 2002

(30) Foreign Application Priority Data
Jan. 21, 2002 (TW) 91100849

(51) Int. Cl. C23F 1/00; B44C 1/22; C03C 15/00; C03C 25/68

(52) U.S. Cl. 216/58

(57) ABSTRACT

A via hole defining process performed in one chamber is described. A substrate with a dielectric layer thereon is provided. A patterned mask layer having an opening therein is formed on the dielectric layer. An anisotropic etching process is conducted to form a via hole in the dielectric layer within an etching chamber by using the patterned mask layer as a mask. A portion of the patterned mask layer around the via hole is then removed by an oxygen (O₂) treatment in the same etching chamber, while the profile of the via hole is retained. Another anisotropic etching process is conducted in the same etching chamber to remove a portion of the dielectric layer to broaden the upper portion of the via hole. Because the via hole defining process is performed within one single chamber, the whole process time can be decreased.

### CROSS-REFERENCE TO RELATED APPLICATION

This application claims the priority benefit of Taiwan application serial no. 91100849, filed Jan. 21, 2002.

### BACKGROUND OF THE INVENTION

1. Field of Invention

The present invention relates to a via process in a semiconductor process. More particularly, the present invention relates to a via hole defining process performed in one chamber.

2. Description of Related Art

Refer to FIGS. 1A˜1C, FIGS. 1A˜1C illustrate a conventional via hole defining process in a multi-layer interconnection process of a semiconductor device. This via hole defining process is designed to enhance the step coverage effect of a conductive layer filled into the via hole.

Refer to FIG. 1A, a dielectric layer 102 is formed on a substrate 100 and then a patterned photoresist layer 104 is formed on the dielectric layer 102. The patterned photoresist layer 104 has an opening 106 therein.

Refer to FIG. 1B, an isotropic etching 108 is performed to the dielectric layer 102 in a wet etching chamber to form a cavity 110 therein, using the patterned photoresist layer 104 as a mask.

Refer to FIG. 1C, by using the patterned photoresist layer 104 as a mask, an anisotropic etching 112 is conducted to form a via hole 114 in the dielectric layer 102 in a dry etching chamber.

Since the conventional via hole defining process includes two different types of etching steps, at least two etching chambers are required. Therefore, the conventional via hole defining process has a higher time-cost and greater risks of wafer damage from delivering steps between different chambers.

### SUMMARY OF THE INVENTION

Accordingly, this invention provides a via hole defining process completed in a single chamber in order to save the process time and lower the risks of wafer damage.

The via hole defining process of this invention comprises the following steps. A substrate with a dielectric layer thereon is provided and then a patterned mask layer having an opening is formed on the dielectric layer. An anisotropic etching process is then conducted to form a via hole in the dielectric layer within an etching chamber by using the patterned mask layer as a mask. A portion of the patterned mask layer around the via hole is then removed by a dry-etching method, such as oxygen (O₂) treatment, to broaden the opening in the patterned mask layer in the same etching chamber, while the profile of the via hole is retained. Another anisotropic etching process is then conducted to remove a portion of the dielectric layer exposed by the remaining mask layer around the upper portion of the via hole.

In the present invention, a dry-etching method is utilized to broaden the opening in the patterned mask layer, and then an anisotropic etching is performed to broaden the upper portion of the via hole. Therefore, the via hole defining process of the present invention can be completed in a single chamber to save the process time. Moreover, because the via hole defining process is completed in a single chamber, the wafer damage caused by delivering steps between different chambers can be avoided.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIGS. 1A˜1C illustrate the cross-sectional views of the process flow of a conventional via hole defining process; and

FIGS. 2A˜2D illustrate the cross-sectional views of the process flow of a via hole defining process completed in one etching chamber according to a preferred embodiment of this invention.

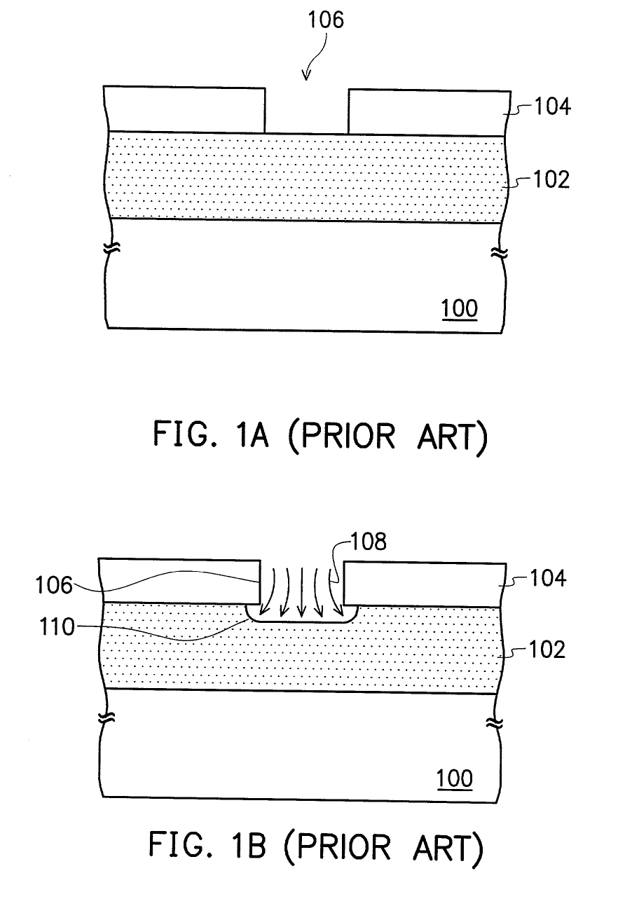

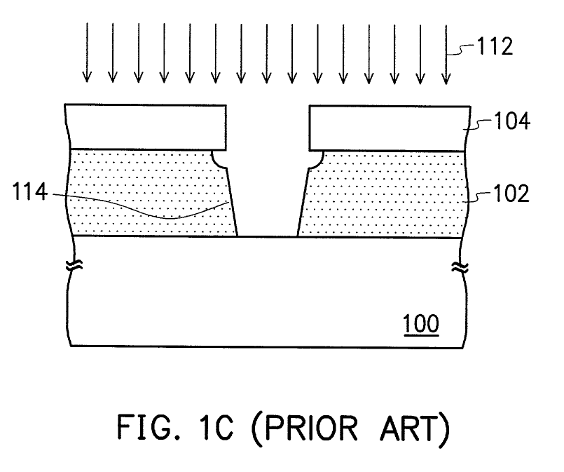

### DESCRIPTION OF THE PREFERRED EMBODIMENTS

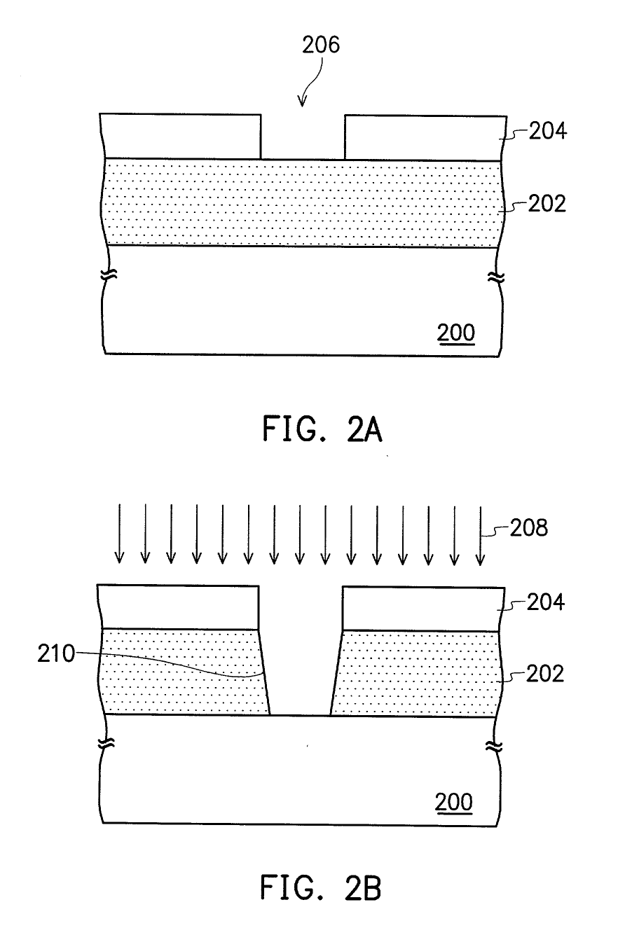

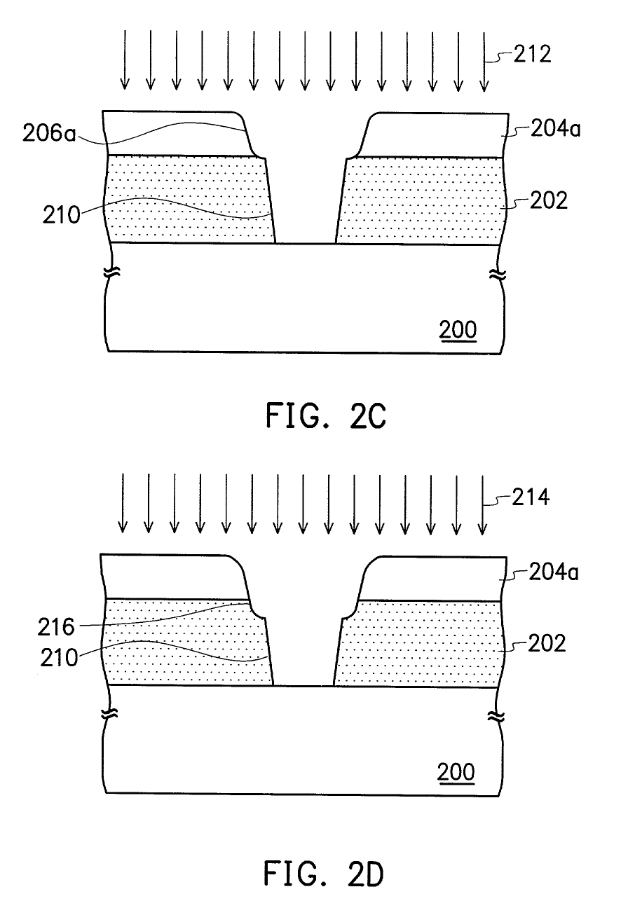

The via hole defining process according to one preferred embodiment of this invention will be described hereinafter by referring to FIGS. 2A˜2D. However, this invention can also be used in other multi-layer interconnection processes including a contact hole defining process.

Refer to FIGS. 2A˜2D, FIGS. 2A˜2D illustrate the cross-sectional views of the process flow of a via hole defining process completed in one etching chamber according to the preferred embodiment of this invention.

Refer to FIG. 2A, a dielectric layer 202 is formed on a substrate 200. A patterned mask layer 204, such as a patterned photoresist layer, is formed on the dielectric layer 202. The patterned mask layer 204 has an opening 206 therein.

Refer to FIG. 2B, the dielectric layer 202 is then subjected to a first anisotropic etching 208 within an etching chamber (not sown) to form a via hole 210 therein by using the patterned mask layer 204 as a mask. The etching chamber can be a clean mode etching chamber, while a reaction gas used in the first anisotropic etching process comprises, for example, fluorohydrocarbons (CₓH_{y}F_{z}) and may further comprise carbon monoxide (CO), oxygen (O₂), or argon (Ar).

Refer to FIG. 2C, an oxygen (O₂) treatment is performed in the same etching chamber to remove a portion of the mask layer 204 around the via hole 210, so as to create a larger opening 206a in the mask layer 204a. A bottom power and a top power used in the oxygen plasma treatment are respectively of a range, for example, from 0.1W to 50W and from 500W to 2000W.

Since the O₂ treatment with a low power is used to remove a portion of the patterned mask layer 204, the profile of the via hole 210 can be substantially maintained. However, to minimize the degree of deformation of the via hole 210, the dielectric layer 202 preferably comprises an inorganic oxide material, such as silicon oxide. On the contrary, in order to be removed by the oxygen plasma, the patterned mask layer 204 may comprise a photoresist, a spin-on polymer (SOP), or an organic low-K material.

Refer to FIG. 2D, the dielectric layer 202 is then subjected to a second anisotropic etching 208 within the same etching chamber to remove a portion of the dielectric layer 202 that is exposed by the remaining mask layer 204a. The upper portion of the via hole 210 is thereby broadened and becomes a larger opening 216 in the dielectric layer 202.

In the subsequent process (not shown), the patterned mask layer 204a is removed and then a conductive layer is formed over the substrate 200 to fill the via hole 210 and the opening 216. A chemical mechanical polishing (CMP) process is conducted later to form a via plug in the via hole and in the opening.

As described in the preferred embodiment of this invention, an O₂ treatment is utilized to broaden the opening in the patterned mask layer and then an anisotropic etching is performed to broaden the upper portion of the via hole. Therefore, the via hole defining process can be completed in a single chamber, thus saving the process time. Moreover, because the via hole defining process is completed in a single chamber, the wafer damage caused by delivering steps between different chambers can be avoided.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

What is claimed is:

1. A via hole defining process performed in one etching chamber, comprising:
providing a substrate having a dielectric layer and a patterned mask layer formed sequentially thereon;
anisotropically etching the dielectric layer in an etching chamber to form a via hole by using the patterned mask layer as a mask;
removing a portion of the patterned mask layer around the via hole in the etching chamber; and
removing a portion of the dielectric layer around an upper portion of the via hole with the remaining patterned mask layer as a mask.

2. The via hole defining process of claim 1, wherein the step of removing a portion of the patterned mask layer comprising performing an oxygen plasma treatment in the etching chamber.

3. The via hole defining process of claim 2, wherein a bottom power used in the oxygen plasma treatment ranges from about 0.1W to about 50W.

4. The via hole defining process of claim 2, wherein a top power used in the oxygen plasma treatment ranges from about 500W to 2000W

5. The via hole defining process of claim 1, wherein a reaction gas used in the step of anisotropically etching the dielectric layer comprises fluorohydrocarbons (CₓH_{y}F_{z}).

6. The via hole defining process of claim 5, wherein the reaction gas further comprises argon (Ar).

7. The via hole defining process of claim 5, wherein the reaction gas further comprises carbon monoxide (CO).

8. The via hole defining process of claim 5, wherein the reaction gas further comprises oxygen (O₂).

9. The via hole defining process of claim 1, wherein a material of the patterned mask layer comprises a photoresist material.

10. The via hole defining process of claim 1, wherein a material of the patterned mask layer comprises a spin-on polymer.

11. The via hole defining process of claim 1, wherein a material of the patterned mask layer comprises an organic low dielectric constant (low-K) material.

12. The via hole defining process of claim 1, wherein a material of the dielectric layer comprises an inorganic oxide material.

13. A via hole defining process, comprising:
providing a substrate having a dielectric layer thereon;
forming a patterned mask layer on the dielectric layer, wherein the patterned mask layer has at least one opening formed therein;
performing a first anisotropic etching process to form a via hole in the dielectric layer by using the patterned mask layer as a mask;
removing a portion of the patterned mask layer around the via hole with an oxygen plasma treatment; and
performing a second anisotropic etching process to remove a portion of the dielectric layer around an upper portion of the via hole by using the remaining patterned mask layer as a mask, wherein the first anisotropic etching process, the second anisotropic etching process, and the oxygen plasma treatment are performed in one single etching chamber.

14. The via hole defining process of claim 13, wherein a bottom power used in the oxygen plasma treatment ranges from about 0.1W to about 50W.

15. The via hole defining process of claim 13, wherein a top power used in the oxygen plasma treatment ranges from about 500W to 2000W

16. The via hole defining process of claim 13, wherein a reaction gas used in the first or the second anisotropic etching process comprises fluorohydrocarbons (CₓH_{y}F_{z}).

17. The via hole defining process of claim 16, wherein the reaction gas further comprises argon (Ar).

18. The via hole defining process of claim 16, wherein the reaction gas further comprises carbon monoxide (CO).

19. The via hole defining process of claim 16, wherein the reaction gas further comprises oxygen (O₂).

20. The via hole defining process of claim 13, wherein a material of the patterned mask layer comprises a photoresist material.

21. The via hole defining process of claim 13, wherein a material of the patterned mask layer comprises a spin-on polymer (SOP).

22. The via hole defining process of claim 13, wherein a material of the patterned mask layer comprises an organic low dielectric constant (low-K) material.

23. The via hole defining process of claim 13, wherein a material of the dielectric layer comprises an inorganic oxide material.
